(19) United States
(12) Patent Application Publication
(10) Pub. No.: US 2017/0127624 A1
(43) Pub. Date: May 11, 2017

(54) UNDERSTORY AND BRUSH MANAGEMENT APPARATUS AND METHOD

(71) Applicant: Bill OLSON, Minneapolis, MN (US)

(72) Inventor: Bill OLSON, Minneapolis, MN (US)

(21) Appl. No.: 15/210,197

(22) Filed: Jul. 14, 2016

Related U.S. Application Data
(60) Provisional application No. 62/194,032, filed on Jul. 17, 2015.

(51) Int. Cl. A01G 23/099; B27L 11/00; A01G 23/081

(52) U.S. Cl. CPC A01G 23/099; A01G 23/081; B27L 11/00

(57) ABSTRACT

A brush management system that includes a feller-buncher-cutter for cutting brush and moving cut material, and a chipper for receiving the b's rush material.

### TECHNICAL FIELD

Various embodiments described herein relate to a understory and brush management apparatus and a method for the same. The inventions can be used to clear woods of undesired trees and immediately chip the trees after removing or cutting them.

### BACKGROUND OF THE INVENTION

Some hobby farmers, municipalities and other private landowners have forests or forested parts of land. Many times, it is desired to cut trails through these forested parts of land. At other times, it is necessary to selectively remove smaller trees and brush from the understory. Generally, smaller unmarketable trees are removed so that the more marketable trees can more freely grow. In other instances, non-native species, such as buckthorn, are overtaking a native forest. Such a species is bothersome as a walk in the woods is less enjoyable due to the density of the nonnative species and the fact that they may have undesirable features, such as thorns.

There are ways to remove or manage an understory. However, current ways seem to have disadvantages. For example, state parks and municipalities commonly organize work parties to remove or manage the understory. Much of the work is done by hand. This is inefficient as the process is not mechanized. For the individual landowner who is unable to assemble a band of volunteers, managing the understory is nearly impossible. One person or one family can barely keep up with a woods of any size.

There are machines that can remove parts of the forest. However, these machines are large and also tend to be expensive. In many instances, these machines are unable to maneuver around marketable trees. In some instances, the machines are able to move around marketable trees but it is done so with much effort. In still other instances, having large machines do these tasks on smaller plots of land and smaller forests is inefficient and are ecologically unfriendly. The large machines are specialized and so in order to do the job, the forest must be traveled by several machines. Each heavy machine disrupts the forest floor to cut the understory and then to haul it out and process it further. The heavy machinery does not minimally disrupt the forest floor. It is also not economical to move heavy machinery in to do a “small job” as there are high costs associated with transporting the machinery to the job site for a short time.

Another problem is that large forest fires are a rapidly increasing problem in the Western United States and Canada, and millions of dollars are being spent to control them. The effort is limited by available funds. However when fires break out, billions of dollars are spent on an emergency basis, extinguishing them and repairing the damage.

Treating forests to reduce the strength and number of fires is an ongoing activity, however, according to the USDA Forest Service, “Treatment costs are increased by a need to treat large numbers of low-volume stems less than 4 inches in diameter. Gross costs can range from $35 to over $1000 per acre depending on type of operation, terrain, and the number of trees treated . . . . While 86% of the trees that would be cut are less than 10 inches, most of the volume that would be treated comes from the 14% of the trees that are larger than 10 inches in diameter. This is the central dilemma of fuel reduction treatments—large numbers of small diameter trees with relatively little volume that can be feasibly utilized must be treated.” The presently available equipment used to carry out this work was designed for conventional timber harvesting and is not particularly appropriate for reduction of smaller brush and trees of the understory.

### SUMMARY OF THE INVENTION

A brush management system that includes a feller-buncher-cutter for cutting brush and moving cut material, and a chipper for receiving the brush material.

### BRIEF DESCRIPTION OF THE DRAWINGS

The embodiments will be readily understood by the following detailed description in conjunction with the accompanying drawings, wherein like reference numerals designate like structural elements, and in which:

FIG. 1 is a schematic view of a small understory brush management system, according to an embodiment of the invention.

FIG. 2 is a perspective view of a collector or slip ring 200 according to an example embodiment.

FIG. 3 is a perspective view of a small understory brush management system after cutting a portion of the underbrush and securing the cut brush with the accumulator, according to an example embodiment.

FIG. 4 is a schematic view of a small understory brush management system after cutting a portion of the underbrush and feeding it to a shredder, according to an example embodiment.

FIG. 5 shows a perspective view of the understory and brush management system, according to an example embodiment.

### DETAILED DESCRIPTION

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

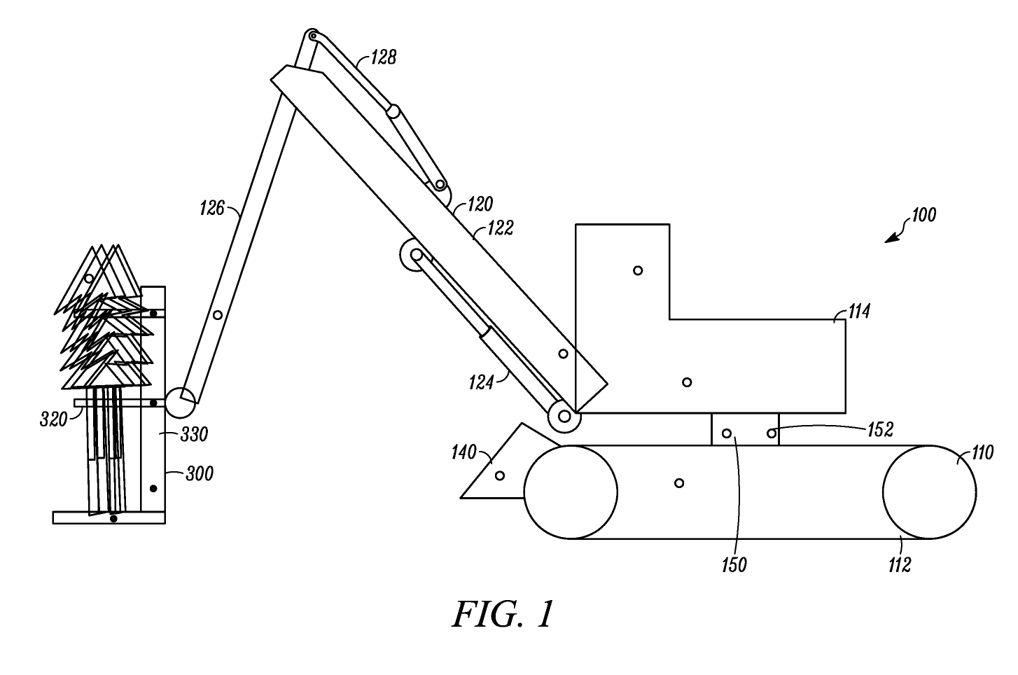

FIG. 1 is a schematic view of a small understory brush management system 100, according to an embodiment of the invention. The understory brush management system 100 includes a mini excavator base 110. The mini excavator base 110 has a tracked chassis 112 for low pressure, low environmental impact travel through a forest. A cab 114 is rotatably mounted to the mini excavator base 110. In one embodiment the 114 is capable of 360° rotation with substantially zero overhang. This minimizes the impact on a forest. The 360° rotation of the cab 114 over the mini excavator base 110 also minimizes the possibility that the cab will impact or scrape on larger, marketable trees. Attached to the mini excavator base 110 is an articulated knuckle boom 120 that is hydraulically controlled and is capable of carrying and manipulating of an attachment at its free end. The knuckle boom 120 includes an elongated arm 122 which can be raised and lowered by a hydraulic ram 124. The knuckle boom 120 also includes an arm 126 which is controlled by hydraulic ram 128. The hydraulic rams 124 and 128 are controlled from within the cab 114. Specifically, the controls sit in front of the operator when the operator is in a seat within the cab 114. The arm 126 also includes telescoping portion.

Attached to the mini excavator base 110 is a chipper 140. The chipper 140 receives brush cut from an understory of the forest or from other sources and converts them to chipped material, such as wood chips. Attached to the arm 126 is a feller-buncher-cutter 300. The feller bunter cutter 300 gathers small trees and other brush into a bunch and cuts the bunch off. The feller-buncher-cutter also includes arms 320 and a carriage 330. The arm 126 includes a telescoping portion. The telescoping portion of the arm 126 elongates the arm so that the feller-buncher-cutter 300 can reach the chipper or get close to the chipper 140.

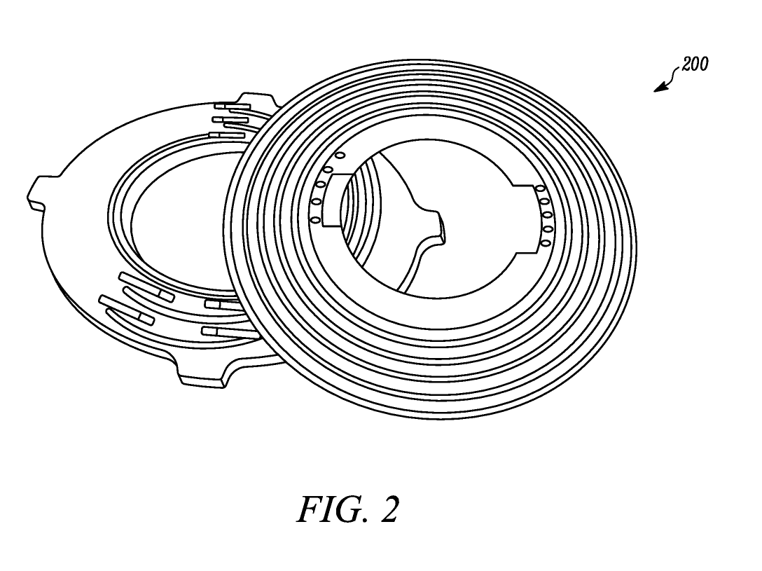

The chipper 140 operates from within the cab 114. The cab 114 is rotatably attached to the mini excavator base 110 by way of a turntable 150. The turntable also includes a collector 200. FIG. 2 is a perspective view of a collector or slip ring 200 according to an example embodiment. The collector or slip ring 200 is mounted at the base of the mast of the excavator chassis turntable 150. The collector or slip ring 200 allows power to be passed between the source of power and the cab 114. The slip ring 200 also carries control signals to the chipper 140 and the motors driving the hydraulic rams 124, 128. Control signals are also sent to the feller cutter buncher 300 to control the actions of that device attached at the end of arm 126.

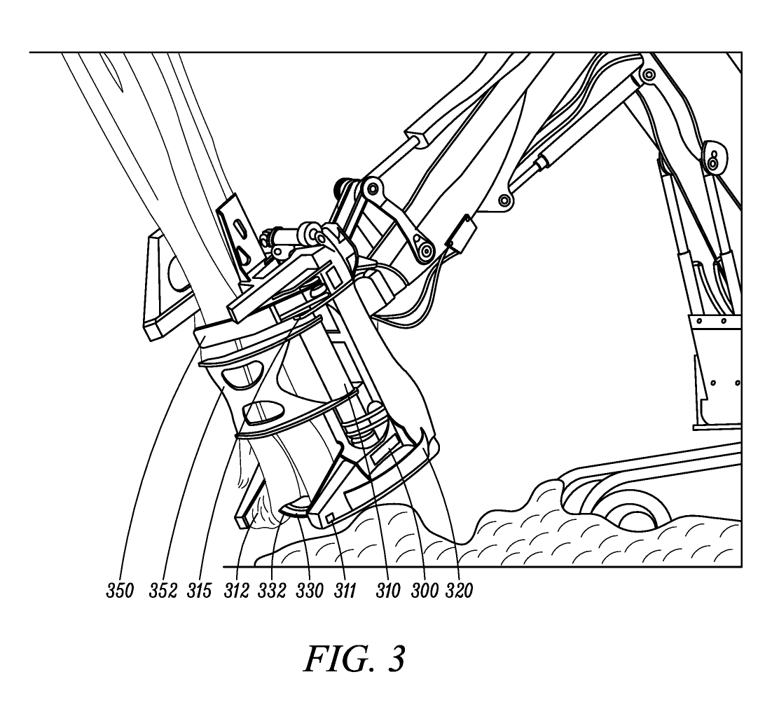

FIG. 3 is a perspective side view of a feller-buncher-cutter 300 attached to the arm 126 of the brush management system 100. The Feller-buncher-cutter 300 is used to fell, or cut down, a number of trees and then to bunch the trees together for transport to the chipper 140 or to a transport. If the trees and brush are delivered to the chipper 140, the chipper chips the felled trees and then spreads the chips on the forest floor. The chips act as a mulch to keep the small trees from becoming larger or to at least slow the process. If the trees and brush are to be removed, the bunched trees are then transported to a storage site for further processing. In some embodiments the bunched trees are delivered to a transport.

The feller-buncher cutters 300 are articulated machines that include a front frame 310 and a rear frame 320 that are pivotally coupled by a hitch 315. The hitch 315 allows the front frame 310 to pivot relative to the rear frame 320 so as to steer the felle-buncher-cutter 300. The front frame 310 includes a front axle 311 having a pair of wheels 312 mounted thereon.

The feller-buncher-cutter 300 further includes a work tool 330 that cuts down trees and secures the cut trees to the feller-buncher-cutter 300. The work tool 330 is mounted on a yoke that is pivotally attached to the front frame of the fell-buncher-cutter 300. The yoke can be raised or lowered relative to front frame 310 in order to position the work tool during operation. The work tool 330 includes a rotating saw 332 which is used to cut down trees. In addition, the work tool 330 has a number of hydraulically powered work arms 350, 352 which are used to secure the trees within the work tool 330 after the trees have been cut down. The arms 350 are the accumulator arms and they arms 352 are the gathering arms which gather the cut trees.

The feller-buncher-cutter 300 and further includes a tilt cylinder which is operable to pivot the work tool 330 relative to the yoke. To unload the trees from the work tool 330, the work tool 330 is tilted forward relative to the yoke and the work arms 350, 352 release the trees from the work tool 330. In one embodiment, the feller-buncher-cutter 300 includes an extension member used to move the felled trees into the chipper 140.

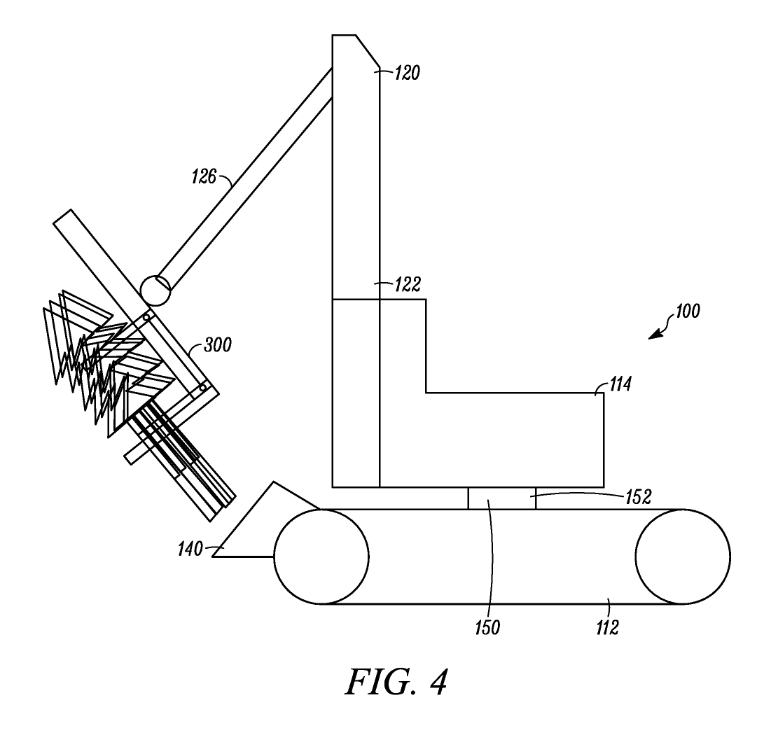

FIG. 4 is a schematic side view of the brush management system 100 after it has felled a plurality of trees and moved the felled trees into a position where the trees can be inserted into the chipper 140, according to an example embodiment. As shown, the arm 122 is essentially vertical and the arm 126 is making a sharp angle with respect to the arm 122 so that the trees and brush in the feller-Buncher-cutter 300 are positioned proximate the chipper 140. In some embodiments, the arm 126 is telescoping so that the feller-buncher-cutter 300 will reach the chipper 140. In another embodiment the frame of the feller-buncher-cutter 300 includes a telescoping complement so that the felled trees can be placed proximate or in the chipper 140.

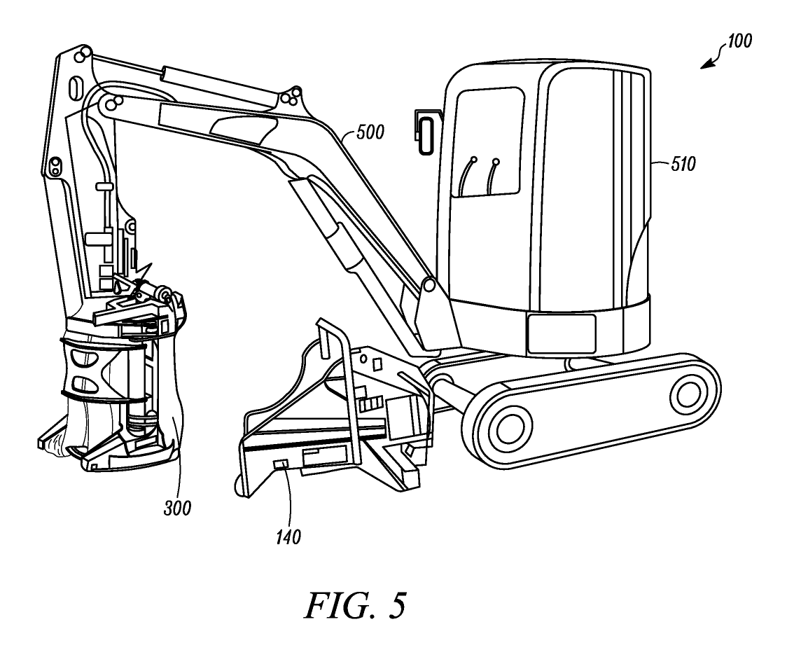

FIG. 5 shows a perspective view of the understory and brush management system 100, according to an example embodiment. The understory and brush management system 100 includes a feller-buncher-cutter 300 and a chipper 140. The feller-buncher-cutter 300 is located on the end of the boom and arm 500 of the understory and brush management system 100. The feller-buncher-cutter 300 is controlled by an operator that sits in the control box 510 of the understory and brush management system 100. The feller-buncher-cutter 300 is located near the chipper 140. The feller-buncher-cutter 300 can be used to cut trees and brush and move the trees and brush right into the chipper 140. The input for the chipper 140 is locate proximate the chipper 140. The chipper 140 chips the trees and brush and discharges the chips direct to the ground. In another embodiment, the chipper discharges chips into a container associated with the understory and brush management system 100. As shown the understory and brush management system 100 is small and lightweight and physical size so that it is very maneuverable. The maneuverability allows movement among the mature trees while minimizing damage to potentially marketable trees. The lightweight and small understory and brush management system 100 cause as much less damage to the forest floor and it is therefore more eco-friendly. The brush management system 100 allows one person to facilitate several previously manual operations, and operate in process a large amount of material in a given time from within the cab or control center 510 of the system 100. This is much more economical than using many big machines both from a financial standpoint and from an ecological standpoint. Use of several big machines is more capital intensive, and also is less maneuverable in forest situations where there may be closely spaced timber. It is contemplated that in an example embodiment, a universal device may be used and outfitted with a feller-buncher-cutter 300 and a chipper 140. In other embodiments, the understory and brush management system may be permanently affixed to the boom and arm of the system 100.

Machinery described is intended to provide surgical like methods for selectively cutting, removing and reducing the size and small trees brush and other nonmarketable words of forest is areas. Potential end-users for this machine could be municipalities, developers, hobby farmers, and private landowners. This

In one embodiment the chipper 140 is scaled modified and is mounted at one end of the many excavator 110. In this embodiment, there is an insufficient gallon per minute capacity produced by the excavator. The chipper is powered by an engine attached to it and with the exception of hookups for start and stop, throttle and clutch controls, is an independent assembly from excavator platform.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed:

1. A brush management system comprising:
a feller-buncher-cutter for cutting brush and moving cut material; and
a chipper for receiving the Brush material.
